(19) United States
(12) Patent Application Publication
(10) Pub. No.: US 2021/0089973 A1
(43) Pub. Date: Mar. 25, 2021

(54) WORK SEAT INDICATION SYSTEM AND WORK SEAT INDICATION METHOD

(71) Applicant: Panasonic Intellectual Property Management Co., Ltd., Osaka (JP)

(72) Inventors: Sonoko HIRASAWA, Kanagawa (JP); Takeshi FUJIMATSU, Kanagawa (JP)

(73) Assignee: Panasonic Intellectual Property Management Co., Ltd., Osaka (JP)

(21) Appl. No.: 16/971,231

(22) PCT Filed: Feb. 7, 2019
(86) PCT No.: PCT/JP2019/004503

§ 371 Date: Aug. 19, 2020

(30) Foreign Application Priority Data
Feb. 22, 2018 (JP) 2018-029350

(51) Int. Cl. G06Q 10/02; G06Q 10/06

(52) U.S. Cl. CPC G06Q 10/02; G06Q 10/0631

(57) ABSTRACT

To present workspaces taking into account the demand of uses while preventing the workspaces from becoming fixed, a processor of a facility management device is configured: to acquire images taken by a camera installed in a work area; to detect an occupancy status of each workspace based on the images; to extract unoccupied workspaces based on a result of detection; to select, in response to an operation of a user of specifying a selection condition regarding work environment, a workspace matching the selection condition specified by the user as a workspace candidate from among the unoccupied workspaces; and to generate workspace presentation information to present the workspace candidate to the user.

### TECHNICAL FIELD

The present invention relates to a workspace presentation system and a workspace presentation method for executing, with a processor, processes of selecting a workspace candidate from among multiple workspaces arranged in a work area and presenting the workspace candidate to the user.

### BACKGROUND ART

In recent years, for the purpose of activation of communication between workers, collaboration beyond departments and divisions, or the like, an increasing number of companies are introducing a shared workspace system in the office, in which users freely select workspaces in which they work.

In offices adopting such a shared workspace system, with an extended period of operation, the workspaces tend to become fixed; namely, the same persons use the same workspaces everyday so that the advantages of the shared workspace system are not demonstrated. Therefore, a technology for preventing the workspaces from becoming fixed is desired.

As such a technology for preventing the workspaces from becoming fixed, conventionally, there is known a technology of randomly selecting, from among unoccupied workspaces, the workspaces to be assigned to users (see Patent Document 1). There is also known a technology of calculating correlation values indicating degrees of correlation between the users and deciding the workspaces to be assigned to the users based on the correlation values (see Patent Document 2).

### PRIOR ART DOCUMENT(S)

### Patent Document(s)

Patent Document 1: JP2010-079585A

Patent Document 2: JP2012-177974A

### SUMMARY OF THE INVENTION

### Task to be Accomplished by the Invention

In an office with a shared workspace system, some users may desire to use a workspace suitable for the task at hand. However, the conventional technology does not take into account such demand of users and may give users an impression that the workspaces are specified forcibly, and this may impair the advantage of the shared workspace system that the users can freely select the workspaces.

In view of the above, a primary object of the present invention is to provide a workspace presentation system and a workspace presentation method capable of presenting workspaces taking into account the demand of users while preventing the workspaces from becoming fixed.

### Means to Accomplish the Task

A workspace presentation system of the present invention is a workspace presentation system for execute, with a processor, process of selecting a workspace candidate from among multiple workspaces arranged in a work area and presenting the workspace candidate to a user, wherein the processor is configured: to acquire detection information of a sensor installed in the work area, to detect an occupancy status of each workspace based on the detection information, and to extract unoccupied workspaces based on a result of detection; to select, in response to an operation of the user of specifying a selection condition regarding work environment, a workspace matching the selection condition specified by the user as a workspace candidate from among the unoccupied workspaces; and to generate workspace presentation information to present the workspace candidate to the user.

A workspace presentation method of the present invention is a workspace presentation method for executing, with a processor, a process of selecting, from among multiple workspaces arranged in a work area, a workspace candidate and presenting the workspace candidate to a user, the method comprising: acquiring detection information of a sensor installed in the work area, detecting an occupancy status of each workspace based on the detection information, and extracting unoccupied workspaces based on a result of detecting; selecting, in response to an operation of the user of specifying a selection condition regarding work environment, a workspace matching the selection condition specified by the user as a workspace candidate from among the unoccupied workspaces; and generating workspace presentation information presenting the workspace candidate to the user.

### Effect of the Invention

According to the present invention, a user is caused to specify a selection condition regarding the work environment, and a workspace matching the selection condition is presented to the user as a workspace candidate. Thereby, it is possible to present workspaces taking into account the demand of users while preventing the workspaces from becoming fixed.

### BRIEF DESCRIPTION OF THE DRAWING(S)

FIG. 1 is an overall configuration diagram of a workspace presentation system according to the present embodiment;

FIG. 2 is an explanatory diagram showing a layout of an office, an installation status of camera 1, and a setting status of detection areas;

FIG. 3 is a block diagram showing a schematic configuration of a facility management device 2, a digital signage device 3, and a user terminal 4;

FIG. 4 is an explanatory diagram showing a workspace map screen in an initial state displayed in the digital signage device 3;

FIG. 5 is an explanatory diagram showing a mode specifying screen displayed on the digital signage device 3;

FIG. 6 is an explanatory diagram showing a workspace map screen in a workspace presentation state displayed on the digital signage device 3;

FIG. 7 is a flowchart showing a procedure of a process performed by the facility management device 2;

FIG. 8 is a flowchart showing a procedure of a process performed by the facility management device 2;

FIG. 9 is a flowchart showing a tentative reservation management procedure performed by the facility management device 2; and

FIG. 10 is a flowchart showing a procedure of an occupancy management process performed by the facility management device 2.

### MODES FOR CARRYING OUT THE INVENTION

A first aspect of the present invention made to accomplish the object is a workspace presentation system for execute, with a processor, process of selecting a workspace candidate from among multiple workspaces arranged in a work area and presenting the workspace candidate to a user, wherein the processor is configured: to acquire detection information of a sensor installed in the work area, to detect an occupancy status of each workspace based on the detection information, and to extract unoccupied workspaces based on a result of detection; to select, in response to an operation of the user of specifying a selection condition regarding work environment, a workspace matching the selection condition specified by the user as a workspace candidate from among the unoccupied workspaces; and to generate workspace presentation information to present the workspace candidate to the user.

According to this, a user is caused to specify a selection condition regarding work environment and a workspace matching the selection condition is presented to the user as a workspace candidate. Therefore, it is possible to present workspaces taking into account the demand of users while preventing the workspaces from becoming fixed.

In a second aspect of the present invention, the processor is configured to select, in response to the operation of the user of specifying the selection condition, a workspace where a quiet work environment can be secured as the workspace candidate from among the unoccupied workspaces.

According to this, it is possible to meet the demand of the user to work in a quiet work environment, namely, a calm work environment in which the user can work without being disturbed by people around the user.

In a third aspect of the present invention, wherein the processor is configured to select, in response to the operation of the user of specifying the selection condition, a workspace where a work environment that facilitates communication with people in surroundings can be secured as the workspace candidate from among the unoccupied workspaces.

According to this, it is possible to meet the demand of the user to work while actively communicating with people in the surroundings.

In a fourth aspect of the present invention, the processor is configured to select, in response to the operation of the user of specifying the selection condition, an arbitrary workspace as the workspace candidate from among the unoccupied workspaces.

According to this, it is possible to meet the demand of the user that the workspace can be selected freely.

In a fifth aspect of the present invention, the processor is configured to acquire, as the detection information, one of signal information of a wireless tag carried by the user, image information obtained by a camera capturing an image of the user, information read from an IC card possessed by the user.

According to this, the occupancy state of the workspace can be detected accurately.

A sixth aspect of the present invention is a workspace presentation method for executing, with a processor, a process of selecting, from among multiple workspaces arranged in a work area, a workspace candidate and presenting the workspace candidate to a user, the method comprising: acquiring detection information of a sensor installed in the work area, detecting an occupancy status of each workspace based on the detection information, and extracting unoccupied workspaces based on a result of detecting; selecting, in response to an operation of the user of specifying a selection condition regarding work environment, a workspace matching the selection condition specified by the user as a workspace candidate from among the unoccupied workspaces; and generating workspace presentation information presenting the workspace candidate to the user.

According to this, similarly to the first aspect of the present invention, it is possible to present workspaces taking into account the demand of users while preventing the workspaces from becoming fixed.

In the following, an embodiment of the present invention will be described with reference to the drawings.

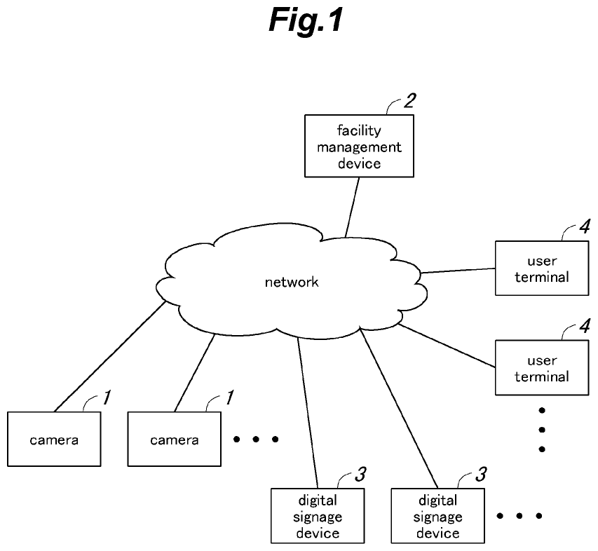

FIG. 1 is an overall configuration diagram of a workspace presentation system according to the present embodiment.

This workspace presentation system is for presenting workspaces to users in an office with a shared workspace system, and includes cameras 1, a facility management device 2, digital signage devices 3, and user terminals 4. The cameras 1, the facility management device 2, the digital signage devices 3, and the user terminals 4 are connected via a network.

The camera 1 are installed in the office to capture images of persons staying in the office.

The facility management device 2 is configured to receive images transmitted from the cameras 1 and to analyze the images, thereby generating display information regarding an occupancy status (unoccupancy status) of the workspaces.

The digital signage devices 3 are installed at an entrance of respective offices and each is configured to display the occupancy status (unoccupancy status) of the office based on the display information transmitted from the facility management device 2. The digital signage device 3 is equipped with a touch panel so that necessary screen operations can be performed by touch operation. When a user enters the office, the user views the screen of the digital signage device 3, performs an operation of selecting a workspace, and sits at the presented workspace to do the task.

The user terminals 4 are to be carried by users and each may be a portable PC (a notebook PC, a tablet PC, and the like), a mobile terminal such as a smart phone, or the like. The user terminal 4 is provided with a browser to display the screen similar to that of the digital signage device 3. When a user moves to another office, the user can confirm beforehand the occupancy status of the office with the user terminal 4 and can select the workspace to use.

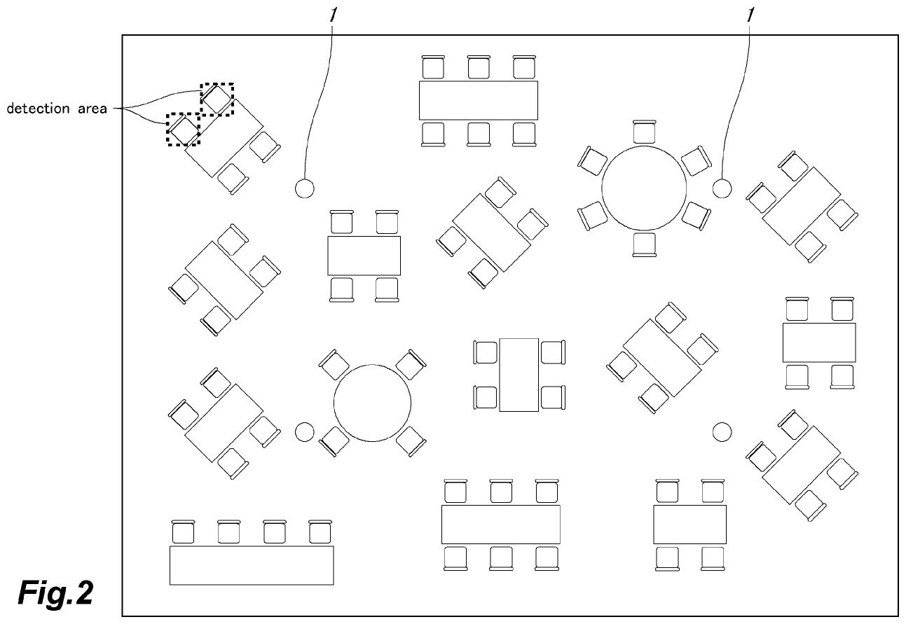

Next, description will be made of a layout of an office, an installation status of the cameras 1, and detection areas set in the images taken by the cameras 1. FIG. 2 is an explanatory diagram showing a layout of an office, an installation status of the cameras 1, and a setting status of the detection areas.

In the office, desks and workspaces (chairs) are arranged and each user sits at one of the workspaces to do the task.

The cameras 1 are install on the ceiling of the office to capture images of persons staying in the office. As the cameras 1, cameras such as omnidirectional cameras configured to capture images having a field of view of 360 degrees by using a fisheye lens, box cameras configured to capture images having a prescribed angle of view, or the like are used.

In the present embodiment, a detection area (rectangular area shown by a dotted line) is pre-set for each workspace in the images taken by the cameras 1, and based on the images of the detection areas, whether each workspace is occupied by a person is detected.

Each detection area is set at a position where a body of the person seated at the workspace is supposed to be present, and the detection areas are set based on the size of the body of the person such that one detection area corresponds to one person. Each detection area may be set by the user performing an operation of specifying a range of the detection area on the screen displaying the images taken by the cameras 1, but it is also possible to detect objects (chairs and desks) in the images taken by the cameras 1 and to set the detection areas based on the detection result.

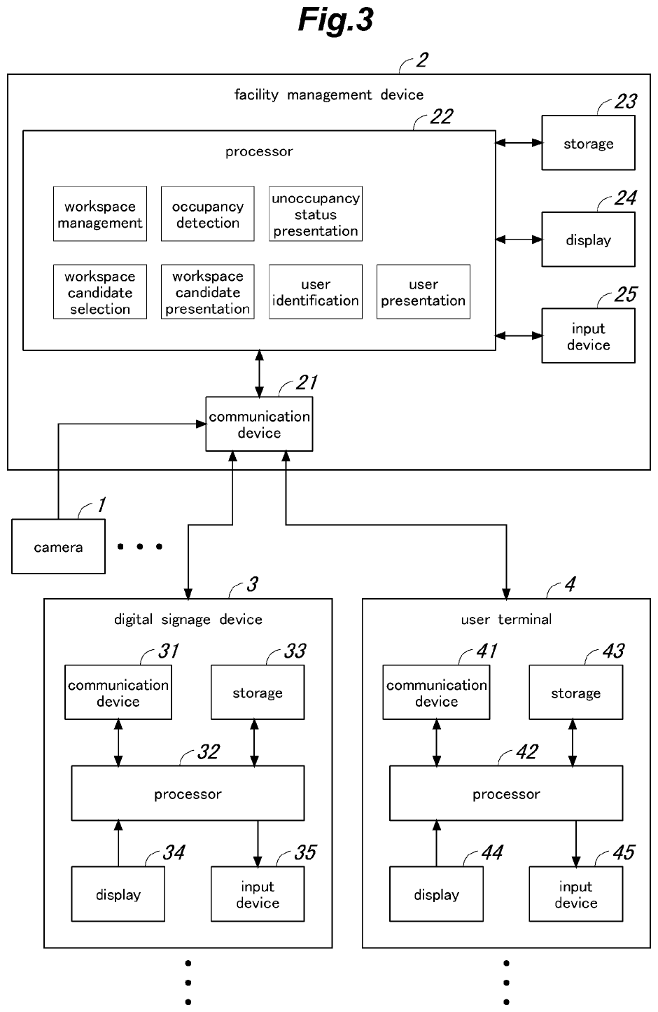

Next, description will be made of the schematic configuration of the facility management device 2, the digital signage device 3, and the user terminal 4. FIG. 3 is a block diagram showing the schematic configuration of the facility management device 2, the digital signage device 3, and the user terminal 4.

The facility management device 2 is provided with a communication device 21, a processor 22, a storage 23, a display 24 (display device), and an input device 25.

The communication device 21 is configured to communicate with the cameras 1 to receive the images transmitted from the cameras 1. Further, the communication device 21 is configured to communicate with the digital signage devices 3 and the user terminals 4 to deliver screen display information to the digital signage devices 3 and the user terminals 4 and to receive operation information from the digital signage devices 3 and the user terminals 4.

The storage 23 is configured to store the images received by the communication device 21 from the cameras 1, various setting information such as setting information regarding the detection areas, programs to be executed by the processor 22, and so on.

The display 24 is configured to display a screen (not shown in the drawings) for inputting the detection areas and the like. The input device 25 is used by an operator to perform an operation such as inputting the detection areas.

The processor 22 performs various processes by executing the programs stored in the storage 23. In the present embodiment, the processor 22 performs processes of workspace management, occupancy detection, unoccupancy status presentation, workspace candidate selection, workspace candidate presentation, user identification, and user presentation.

In the process of workspace management, if it is determined in the process of occupancy detection that a workspace is occupied, the state of the workspace is set to “occupied,” and if it is determined that a workspace is unoccupied, the state of the workspace is set to “unoccupied” (occupancy management). Also, when the user selects a presented workspace, the state of the workspace is set to “tentatively reserved” (tentative reservation management). Further, when the user selects a presented workspace after specifying a selection mode of “quiet,” the attribute of the workspace is set to “quiet,” and when the user selects a presented workspace after specifying a selection mode of “mingle,” the attribute of the workspace is set to “mingle.”

In the process of occupancy detection, based on the images taken by the cameras 1, whether each workspace is occupied by a user is detected in real time. In the present embodiment, staying of a person in each of the detection areas for the respective workspaces set on the images beforehand is detected at regular intervals thereby to acquire information regarding the user presence status in each detection area at regular intervals.

Specifically, whether each workspace is occupied by a person is detected based on a change in the images in the detection area because if a person stays, some change will occur in the images. Specifically, first, from the image at each of successive time points separated by a prescribed sampling period (for example. one minute), an image of the detection area at each time point is cut out. Then, an image change rate is acquired for the image of the detection area at each time point. At this time, by comparing with the image at the immediately preceding time point that is separated by the sampling period, an image change rate relative to the image at the immediately preceding time point is acquired. Subsequently, based on the image change rate at each time point, presence or absence of a person in the detection area is determined. Then, based on the determination result, stay information representing the presence or absence of a person at each of the successive time points separated by the sampling period is generated. Note that in the occupancy detection process, instead of relaying on the image change rate described above, it is possible to use a discriminator that has been made to learn the two classes consisting of an occupied state and an unoccupied state beforehand through deep learning. When performing the occupancy detection process, a likelihood (probability) of the images of the detection area showing the occupied state and a likelihood of the same showing the unoccupied state are obtained by the discriminator and the two likelihoods are compared, whereby it is possible to determine which of occupancy and unoccupancy is shown.

Note that it is also possible to detect an article belonging to the user near the workspace; for example, on the table immediately close to the workspace. In this case, when it is found that an article has newly appeared based on the images around the detection area, it may be determined that the article is the one belonging to the user. Thereby, even when the user leaves the workspace temporarily, the occupied state can be maintained so long as the article belonging to the user remains there.

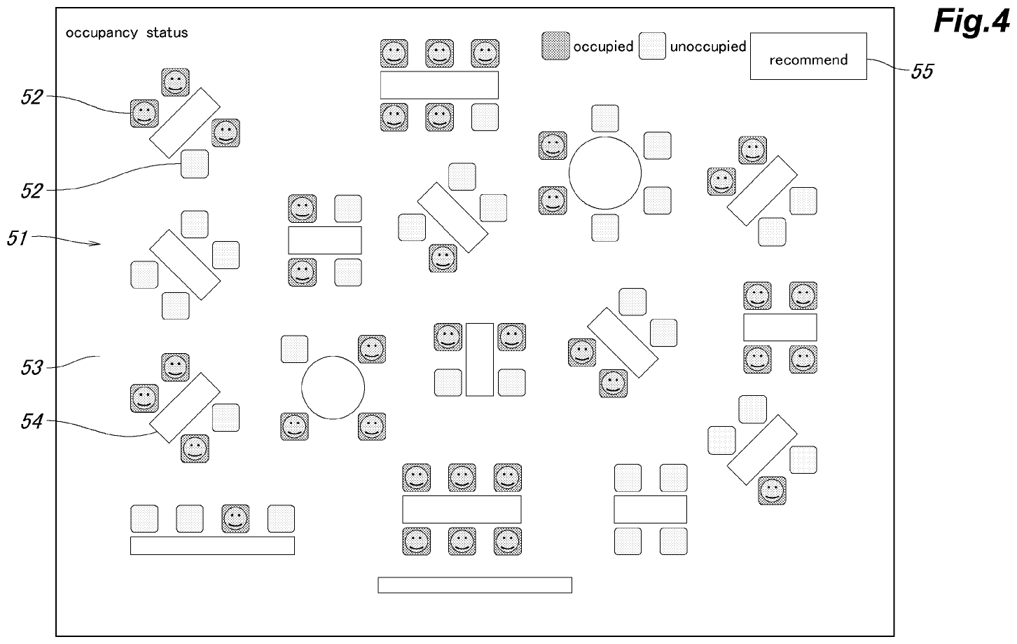

In the process of unoccupancy status presentation, an unoccupancy status (occupancy status) of each workspace is presented to the user. In the present embodiment, a workspace map screen in an initial state (see FIG. 4) is generated, and the screen is caused to be displayed on the digital signage device 3 and the user terminal 4. In this workspace map screen in the initial state, the unoccupancy status of each workspace (occupancy status) is displayed.

In the process of workspace candidate selection, the user is caused to perform an operation of specifying a selection condition regarding the work environment and, a workspace matching the selection condition specified by the user is selected as a workspace candidate from among the unoccupied workspaces acquired by the occupancy detection. Also, in the present embodiment, the user can specify one of three selection modes “quiet,” “mingle,” and “no preference” as the selection condition regarding the work environment.

The selection mode of “quiet” is for meeting the demand of the user to work in a quiet work environment, namely, a calm work environment in which the user can work without being disturbed by people around the user. In the present embodiment, when the selection mode of “quiet” is specified, a workspace near which there is no workspace having the attribute of “mingle” and which is located in an area where a person stay degree is low is selected as a workspace candidate from among the unoccupied workspaces.

By thus selecting a workspace near which there is no workspace having the attribute of “mingle,” users who desire a quiet work environment will be seated next to each other. Thereby, even in a case where the number of users increases and a state where the person stay degree is sufficiently low cannot be maintained, a quiet work environment can be secured.

The selection mode of “mingle” is for meeting the demand of the user to work while actively communicating with people in the surroundings. In the present embodiment, when the selection mode of “mingle” is specified, a workspace near which there is no workspace having the attribute of “quiet” and which is located in an area where the person stay degree is high is selected as a workspace candidate from among the unoccupied workspaces.

By thus selecting a workspace near which there is no workspace having the attribute of “quiet,” users who desire to communicate with people in the surroundings will be seated next to each other. Thereby, the users can actively communicate with people in the surroundings as desired.

The selection mode of “no preference” is for meeting the demand of the user that the workspace can be selected freely because the user has no particular preference for the work environment. In the present embodiment, when the selection mode of “no preference” is specified, a workspace near which there is no workspace having the attribute of “quiet” and which is located in an area where the person stay degree is high is selected randomly as a workspace candidate from among the unoccupied workspaces.

By thus excluding an area near which there is a workspace having the attribute of “quiet,” it is possible to maintain a low person stay degree around the users who desire a quiet work environment.

Here, the person stay degree is the number of persons staying in a prescribed range (stay density), namely, the number of occupied workspaces present within the prescribed range. For example, it is possible to generate, based on the occupancy status of each workspace acquired by the occupancy detection, a heat map representing the person stay degree depending on the positions, and to determine an area where the person stay degree is high (an area where there are many people) and an area where the person stay degree is low (an area where there are a few people) from the heat map.

Note that in the present embodiment, the workspace candidate is selected based on the attribute of the workspaces and the person stay degree, but in some cases, the work environment varies depending on the position of the workspace in the office (near or distant from the entrance). Therefore, a selection mode taking into account the position of the workspace in the office may be prepared as a selection condition for the workspace candidate.

There also are cases where the user desires to communicate with people in another department and cases where the user desires to communicate with people in his/her own department. Therefore, the workspace candidate may be selected by taking into account the department that the user belongs to. In this case, it is preferred to capture an image of the user with a camera provided in the digital signage device 3 and to perform face recognition on the image taken by the camera, thereby to identify the user operating the digital signage device 3 and to acquire the department that the user belongs to.

Also, in the case where the brightness of each workspace differs depending on the positional relationship with lighting apparatuses and windows and the like, some users may prefer light workspaces while other uses may prefer dark workspace. In the case where the temperature changing status of each workspace differs depending on the positional relationship with the outlets of an air conditioner and the like, some users may prefer workspaces with a small temperature change. In the case where the user frequently uses a particular place, such as a meeting space or a lavatory, workspaces near the place may be preferred. In the case where noise comes into the office from the outside, some users may prefer workspace where the noise is small. Also, the workspaces may have different sizes, and a user may prefer a wider workspace depending on the task to be done. Moreover, there may be workspaces having good views and closed workspaces which are surrounded by partitions or the like, and the preference therefor varies depending on the users.

Therefore, it may be preferred to set an environmental condition that varies for each workspace as an attribute of the workspace and to prepare a selection mode taking into account the attribute. Note that such an attribute of the workspace may be set beforehand for each workspace but may also be set based on the detection result of various sensors.

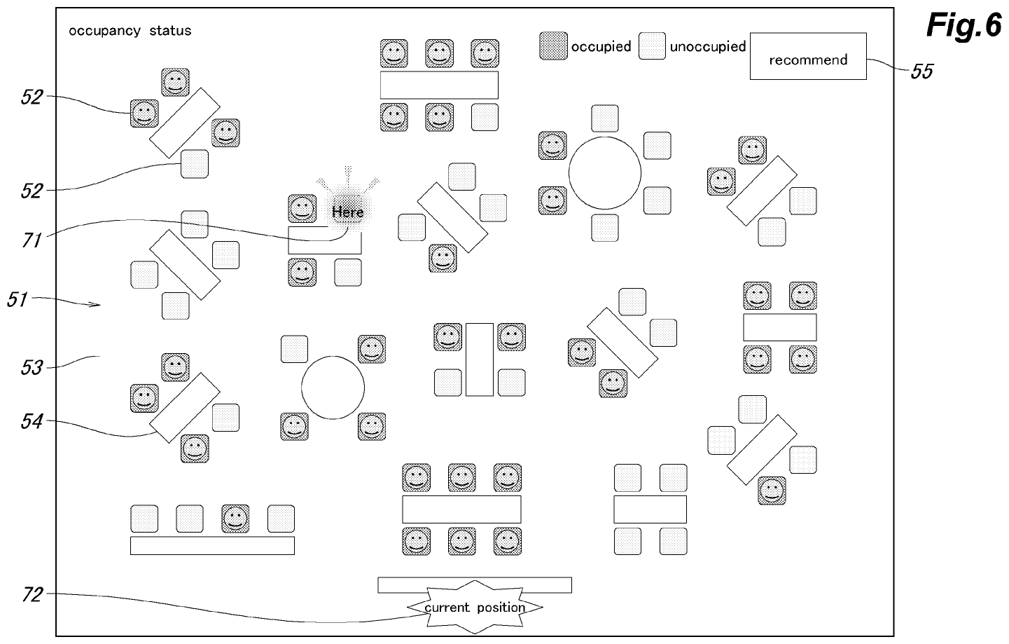

In the process of workspace candidate presentation, the workspace candidate selected in the process of workspace candidate selection is presented to the user. In the present embodiment, a workspace map screen in a workspace presentation state (see FIG. 6) is generated as workspace presentation information, and the screen is caused to be displayed on the digital signage device 3 and the user terminal 4. In the workspace map screen in the workspace presentation state, the workspace candidate is highlighted. In a case where multiple workspace candidates matching the selection condition specified by the user are found in the process of workspace candidate selection, the multiple workspaces candidates are presented.

In the process of user identification, the user using each workspace is identified. In the present embodiment, a receiver for a wireless tag carried by the user is installed in each workspace so that when the user is seated at the workspace, a signal transmitted from the wireless tag (including identification information of the user) is received by the receiver, whereby the user using the workspace is identified.

It is also possible to identify the user using the workspace by installing a camera in each workspace to capture an image of the face of the user seated in the workspace and performing face matching (image recognition) to compare the feature information of the face of the person shown in the image captured by the camera with the feature information of the face of each user registered in the user database. Note that the face matching may be performed based on the images taken by the cameras 1 installed in the office.

It is also possible to identify the user using the workspace by installing a card reader in each workspace to read an IC card possessed by the user so that the identification information of the user stored in the IC card is acquired when the user is seated at the workspace and puts the IC card over the card reader.

Also, the user may cause the user terminal 4 possessed by the user to display the workspace map screen (see FIG. 4 and FIG. 6) and perform an operation of inputting the position of the workspace used by the user on the workspace map screen, so that the user using the workspace is identified. In this case, the identification information of the user may be acquired from the login information (the user ID or the like).

Note that in the present embodiment, the occupancy state of each workspace is detected based on the images taken by the cameras 1 installed in the office, but it is also possible to detect the occupancy status of the workspace by using the identification information of the user acquired from the signal information of the wireless tag received by the receiver, the image information captured by the camera for each workspace, the information read from the IC card by the card reader, or the like.

In the process of user presentation, information of the user seated at each workspace is presented. In the present embodiment, the information of the user seated at each workspace (face image, name, department, etc.) is displayed in the workspace map screen (see FIG. 4 and FIG. 6) displaying the occupancy status.

Each digital signage device 3 is equipped with a communication device 31, a processor 32, a storage 33, a display 34, and an input device 35.

The communication device 31 is configured to communicate with the facility management device 2. The storage 33 is configured to store programs to be executed by the processor 32 and the like. The processor 32 is configured to control operations of various parts of the digital signage device 3 and, in response to an operation performed by the user on the input device 35, receives the display information of the screen (see FIG. 4 to FIG. 6) transmitted from the facility management device 2 with the communication device 31 and causes the display 34 to display a screen in accordance with the display information.

Note that the input device 35 consists of a touch panel and, in combination with a display panel serving as the display 34, constitutes a touch panel display.

Each user terminal 4 is equipped with a communication device 41, a processor 42, a storage 43, a display 44, and an input device 45.

The communication device 41 is configured to communicate with the facility management device 2. The storage 43 is configured to store programs to be executed by the processor 42 and the like. The processor 42 is configured to control operations of various parts of the user terminal 4 and in response to an operation performed by the user on the input device 45, receives the display information of the screen (see FIG. 4 to FIG. 6) transmitted from the facility management device 2 with the communication device 41 and causes the display 44 to display a screen in accordance with the display information.

Note that when the user terminal 4 is a tablet terminal or the like, the input device 45 consists of a touch panel and, in combination of a display panel serving as the display 44, constitutes a touch panel display.

Next, description will be made of the workspace map screen in the initial state displayed on the digital signage device 3. FIG. 4 is an explanatory diagram showing the workspace map screen in the initial state.

In the digital signage device 3, usually the workspace map screen in the initial state is displayed. In this workspace map screen in the initial state, a workspace map 51 representing the occupancy status (unoccupancy status) of each workspace in the office is displayed. In this workspace map 51, workspace icons 52 representing the occupancy status of the respective workspaces are displayed to be superimposed on an area map 53 (map image) representing the layout of the office. The area map 53 also has desk images 54 drawn thereon.

The display mode of each workspace icon 52 changes depending on the occupancy status (occupied or unoccupied). In the present embodiment, when occupied, the face image of the user is displayed on the workspace icon 52. Note that it is also possible to display characters representing occupancy or unoccupancy depending on the occupancy status or to change the color depending on the occupancy status. When the workspace icon 52 is operated, detailed in formation of the user (name, department, etc.) is displayed.

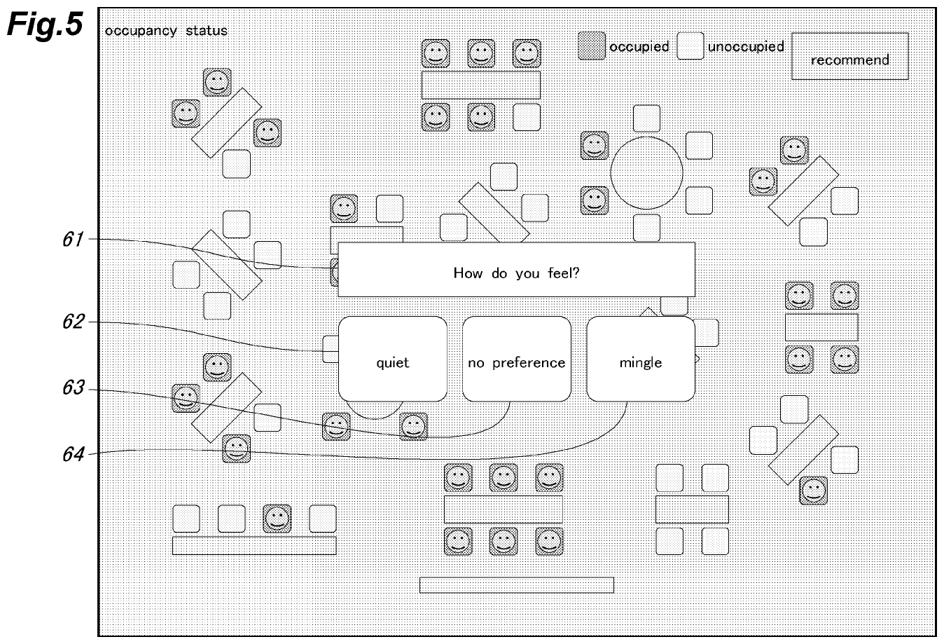

Also, this workspace map screen is provided with a recommend button 55. When the recommend button 55 is operated, the screen transitions to a mode setting screen (see FIG. 5).

Note that a similar workspace map screen is displayed by the browser on the user terminal 4.

Next, description will be made of the mode specifying screen displayed on the digital signage device 3. FIG. 5 is an explanatory diagram showing the mode specifying screen.

When the user operates the recommend button 55 in the workspace map screen in the initial state (see FIG. 4), the screen transitions to the mode specifying screen.

In this mode specifying screen, a message 61 for guiding the screen operation (for example “How do you feel?”) and multiple mode specifying buttons 62 to 64 for specifying a selection mode regarding the work environment are displayed on the workspace map screen in a superimposed manner. In the present embodiment, the user can specify one of the three selection modes “quiet,” “mingle,” and “no preference” as the selection mode regarding the work environment.

Note that a similar mode specifying screen is displayed by the browser on the user terminal 4.

It is also possible to provide the digital signage device 3 with a human sensor configured to detect a person using infrared light or the like so that the user is detected when the user stands in front of the digital signage device 3 before entering the office, and in response to this, the screen of the digital signage device 3 is caused to transition from the workspace map screen in the initial state (see FIG. 4) to the mode specifying screen.

Also, it is possible to display a message for guiding the screen operation and a button for specifying the selection mode regarding the work environment in the workspace map screen in the initial state (see FIG. 4) and to omit the mode specifying screen.

Next, description will be made of the workspace map screen in the workspace presentation state displayed on the digital signage device 3. FIG. 6 is an explanatory diagram showing the workspace map screen in the workspace presentation state.

The workspace map screen in the workspace presentation state (workspace candidate presentation screen) is displayed when in the mode specifying screen (see FIG. 5) the user operates one of the mode specifying buttons 62 to 64.

In the workspace map screen in the workspace presentation state, the workspace map 51 is displayed similarly to the workspace map screen in the initial state (see FIG. 4). Additionally, in this screen, an icon 71 representing the workspace candidate is displayed in a position of the corresponding workspace on the workspace map 51 as highlighting of the workspace candidate. Note that in the case where multiple workspace candidates matching the selection condition (selection mode) specified by the user are found, icons 71 representing the multiple workspace candidates are displayed. Further, in this screen, an icon 72 indicating the current position of the user is displayed. Also, when guiding the workspace candidate, a number, sign, or the like assigned to each workspace beforehand may be displayed near the icon 71.

When the user performs an operation of selecting a workspace in the workspace map screen in the workspace presentation state, specifically, operates the icon 71 of the workspace candidate, the workspace selected by the user is set in a tentatively reserved state.

Note that a similar workspace map screen in the workspace presentation state is displayed by the browser on the user terminal 4.

In a case where there are multiple offices, a workspace in any of the multiple offices may be presented. Namely, when the office that the user is going to enter does not include a workspace matching the selection condition specified by the user but another office includes a workspace matching the selection condition specified by the user, the other office may be presented.

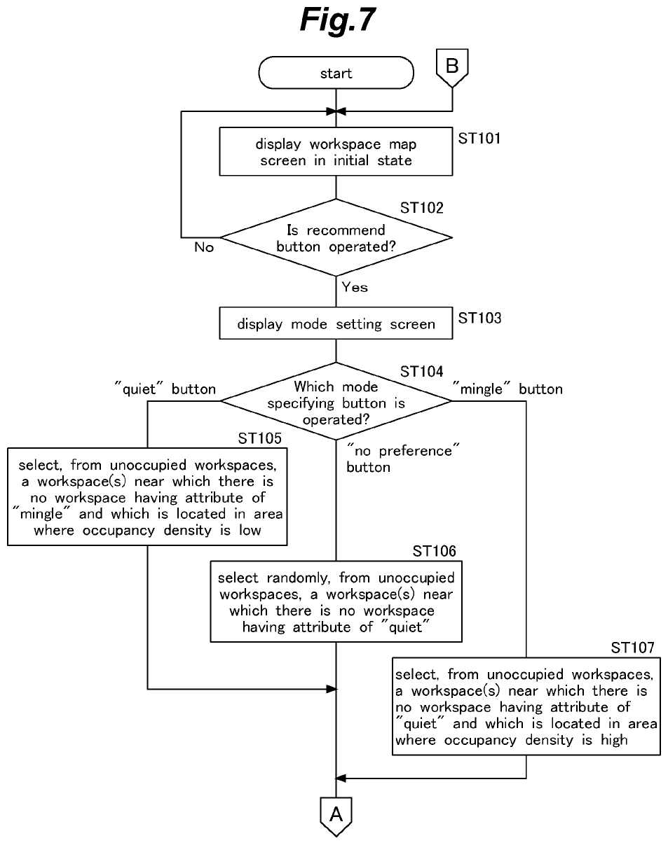

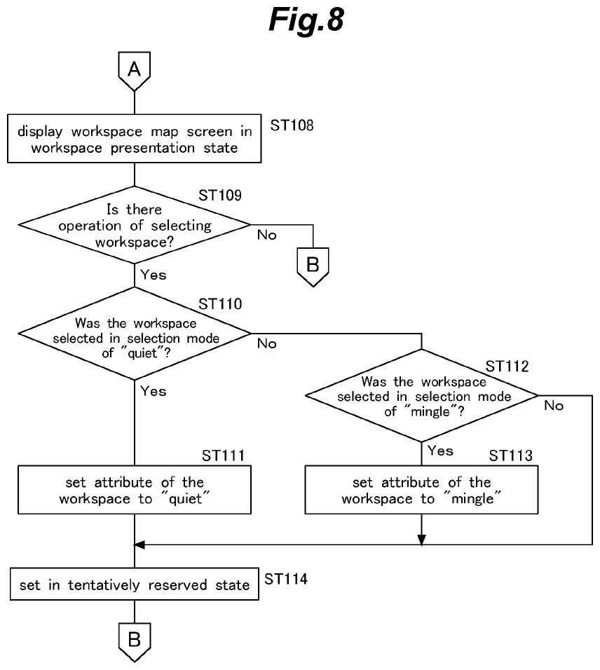

Next, description will be made of the procedure of the process performed by the facility management device 2. FIG. 7 and FIG. 8 are each a flowchart showing the procedure of the process performed by the facility management device 2.

The facility management device 2 first causes the digital signage device 3 installed at the entrance of the office to display the workspace map screen in the initial state (see FIG. 4) (ST101). In this workspace map screen in the initial state, the unoccupancy status of each workspace in the office is displayed.

Next, when the user operates the recommend button 55 in the workspace map screen in the initial state (Yes in ST102), the mode setting screen (see FIG. 5) is caused to be displayed (ST103).

Note that it is also possible to cause the screen to transition to the mode setting screen when the user is detected by a human sensor provided in the digital signage device 3.

Subsequently, it is determined whether the user operates one of the mode specifying buttons 62 to 64 in the mode setting screen (ST104). Here, in the case where the “quiet” mode specifying button 62 is operated, a workspace near which there is no workspace having the attribute of “mingle” and which is located in an area where the person stay degree is low is selected as a workspace candidate from among the unoccupied workspaces (ST105).

In the case where the “no preference” mode specifying button 63 is operated, a workspace near which there is no workspace having the attribute of “quiet” is randomly selected as a workspace candidate from among the unoccupied workspaces (ST106).

In the case where the “mingle” mode specifying button 64 is operated, a workspace near which there is no workspace having the attribute of “quiet” and which is located in an area where the person stay degree is high is selected as a workspace candidate from among the unoccupied workspaces (ST107).

Subsequently, based on the selected workspace candidate, the workspace map screen in the workspace presentation state (see FIG. 6) is displayed (ST108). In this screen, the workspace selected as the workspace candidate is displayed with highlighting.

Subsequently, when the user performs an operation of selecting a workspace in the workspace map screen in the workspace presentation state (Yes in ST109), then, it is determined whether the selected workspace is the one selected in the selection mode of “quiet” (ST110). Here, if the selected workspace is the one selected in the selection mode of “quiet” (Yes in ST110), the attribute of the workspace is set to “quiet” (ST111).

On the other hand, in the case where the selected workspace is not the one selected in the selection mode of “quiet” (No in ST110), then, it is determined whether the selected workspace is the one selected in the selection mode of “mingle” (ST112). Here, if the selected workspace is the one selected in the selection mode of “mingle” (Yes in ST112), the attribute of the workspace is set to “mingle” (ST113).

Note that in the case where the selected workspace is not the one selected in the selection mode of “mingle” (No in ST101), namely, in the case where the selected workspace is the one selected in the selection mode of “no preference,” the attribute of the workspace is not set.

Subsequently, the workspace selected by the user is set in the tentatively reserved state (ST114).

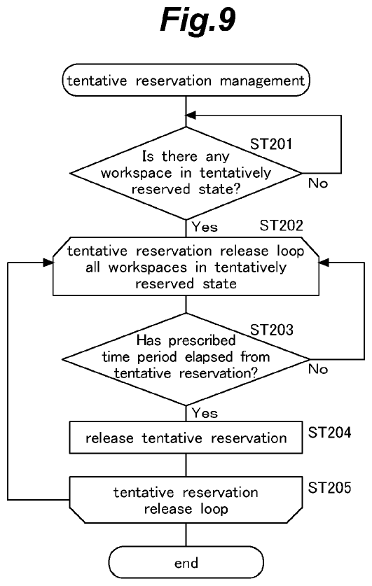

Next, description will be made of the tentative reservation management performed by the facility management device 2. FIG. 9 is a flowchart showing the procedure of the tentative reservation management.

In the present embodiment, when the user performs an operation of selecting a workspace on the digital signage device 3, the workspace is set in the tentatively reserved state, and thereafter, when the user is seated at the workspace and the state of the workspace changes to “occupied,” the tentatively reserved state is released.

However, if the user does not sit at the selected workspace for some reason, the workspace will be left to remain in the tentatively reserved state. If this state continues for an extended period of time, a problem may arise in the workspace presentation thereafter that even though there remains a workspace that meets the demand of the user, the workspace cannot be presented to the user.

Therefore, in the present embodiment, in a case where, after a prescribed time period (for example, five minutes) has elapsed from when the user performed an operation of selecting a workspace and the workspace was set in the tentatively reserved state, the user is not seated at the workspace, namely, the state of the workspace has not changed to “occupied,” the tentatively reserved state of the workspace is released.

Specifically, first, it is determined whether there is any workspace in the tentatively reserved state (ST201). Here, in the case where there is any workspace in the tentatively reserved state (Yes in ST201), then, a process of tentative reservation release is performed on the all workspaces in the tentatively reserved state (ST202 to ST205).

In the process of tentative reservation release, for each workspace in question, it is determined whether the prescribed time period has elapsed from the tentative reservation (ST203). Here, if the prescribed time period has elapsed from the tentative reservation (Yes in ST203), the tentatively reserved state of the workspace is released (ST204). On the other hand, if the prescribed time period has not elapsed from the tentative reservation (No in ST204), no particular process is performed, and the process for the next workspace is performed.

The foregoing process is performed regularly at a constant period.

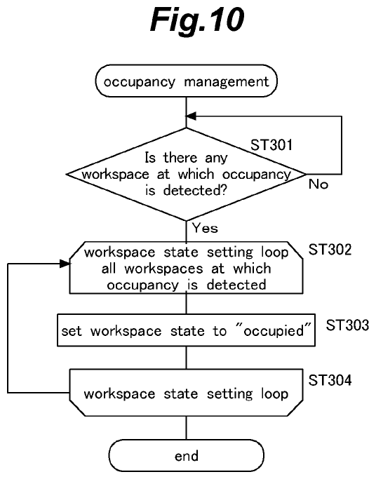

Next, description will be made of an occupancy management process performed by the facility management device 2. FIG. 10 is a flowchart showing a procedure of the occupancy management process.

First, it is determined, in the process of occupancy detection, whether there is any workspace at which occupancy is detected (ST301). Here, in the case where occupancy is detected (Yes in ST301), then, a process of workspace state setting is performed on the all workspaces at which occupancy is detected (ST302 to ST304).

In the process of workspace state setting, each workspace in question is set in an “occupied” state (ST303). On the other hand, the workspaces at which occupancy is not detected remain in an “unoccupied” state.

The foregoing process is performed regularly at a constant period.

As described above, in the present embodiment, the user is caused to specify a selection condition (selection mode), and the workspace candidate matching the selection condition is presented to the user. Therefore, it is possible to present a workspace taking into account the demand of the user. For example, it is possible to present a workspace in a quiet work environment to the user who desires to concentrate on a task because of the business at hand and to present a workspace that facilitates communication with people in the surroundings to the user who feels like working while actively communicating with people around the user.

In a case where the user who is not familiar with the shared workspace system, such as when the user is a business traveler, the user may have difficulty in deciding where he/she should be seated, but in the present embodiment, such a user can use the workspace with ease.

Further, in the present embodiment, the occupancy detection is performed regularly so that the state of the workspace is updated in real time. Thereby, in a case where the user sits at a workspace different from the presented workspace because of the business at hand or in a case where, after being seated at the workspace, the user moves to another workspace, the workspace presentation thereafter can be performed without any trouble.

Note that in a case where there is no or quite few users in the office, most of the workspaces can be workspace candidates, and therefore, the user may perform only the selection mode setting and chose the workspace at his/her own discretion.

Also, three selection modes “quiet,” “mingle,” and “no preference” were described but the selections modes are not limited to them, and a priority mode regarding the place or the number of persons may be added or they may be combined as a second mode.

In the foregoing, description has been made of the embodiment as an example of technology disclosed in the present application. However, the technology in the present disclosure is not limited to this and may be applied to embodiments in which modification, replacement, addition, omission, etc. are made. Also, it is possible to combine various structural elements described in the above embodiment to make a novel embodiment.

### INDUSTRIAL APPLICABILITY

The workspace presentation system and the workspace presentation method according to the present invention have an effect of capable of presenting workspaces taking into account the demand of users while preventing the workspaces from becoming fixed, and are useful as a workspace presentation system and a workspace presentation method for executing, with a processor, processes of selecting a workspace candidate from among multiple workspaces arranged in a work area and presenting the workspace candidate to the user.

### Glossary

1 camera
2 facility management device
3 digital signage device
4 user terminal
21 communication device
22 processor
23 storage
24 display
25 input device

1. A workspace presentation system for execute, with a processor, process of selecting a workspace candidate from among multiple workspaces arranged in a work area and presenting the workspace candidate to a user,
wherein the processor is configured:
to acquire detection information of a sensor installed in the work area, to detect an occupancy status of each workspace based on the detection information, and to extract unoccupied workspaces based on a result of detection;
to select, in response to an operation of the user of specifying a selection condition regarding work environment, a workspace matching the selection condition specified by the user as a workspace candidate from among the unoccupied workspaces; and
to generate workspace presentation information to present the workspace candidate to the user.

2. The workspace presentation system according to claim 1, wherein the processor is configured to select, in response to the operation of the user of specifying the selection condition, a workspace where a quiet work environment can be secured as the workspace candidate from among the unoccupied workspaces.

3. The workspace presentation system according to claim 1, wherein the processor is configured to select, in response to the operation of the user of specifying the selection condition, a workspace where a work environment that facilitates communication with people in surroundings can be secured as the workspace candidate from among the unoccupied workspaces.

4. The workspace presentation system according to claim 1, wherein the processor is configured to select, in response to the operation of the user of specifying the selection condition, an arbitrary workspace as the workspace candidate from among the unoccupied workspaces.

5. The workspace presentation system according to claim 1, wherein the processor is configured to acquire, as the detection information, one of signal information of a wireless tag carried by the user, image information obtained by a camera capturing an image of the user, information read from an IC card possessed by the user.

6. A workspace presentation method for executing, with a processor, a process of selecting, from among multiple workspaces arranged in a work area, a workspace candidate and presenting the workspace candidate to a user, the method comprising:
acquiring detection information of a sensor installed in the work area, detecting an occupancy status of each workspace based on the detection information, and extracting unoccupied workspaces based on a result of detecting;
selecting, in response to an operation of the user of specifying a selection condition regarding work environment, a workspace matching the selection condition specified by the user as a workspace candidate from among the unoccupied workspaces; and
generating workspace presentation information presenting the workspace candidate to the user.
